(19) United States
(12) Patent Application Publication
(10) Pub. No.: US 2023/0069388 A1
(43) Pub. Date: Mar. 2, 2023

(54) COMPUTER IMPLEMENTED METHODS AND SYSTEMS FOR HEALTH PLAN DESIGN ADMINISTRATION

(71) Applicant: Mark Niemeyer, O'Fallon, MO (US)

(72) Inventor: Mark Niemeyer, O'Fallon, MO (US)

(21) Appl. No.: 17/411,247

(22) Filed: Aug. 25, 2021

(51) Int. Cl. G06Q 40/08; G06Q 10/10; G06Q 30/02

(52) U.S. Cl. CPC G06Q 40/08; G06Q 10/10; G06Q 30/0234

(57) ABSTRACT

Computer implemented methods and systems for health plan design administration are disclosed. The method includes bifurcating a member's healthcare services purchase decision between emergency medical and planned medical events. For an emergency medical event, the method includes receiving member information and one or more claims associated with the member from one or more healthcare service providers. The method includes processing one or more claims for determining validity of each claim based upon an emergency medical rule set and facilitating payment amount for one or more claims based on validity. For a planned medical event, the method includes the member purchasing vouchers for healthcare services to be availed by member from one or more healthcare service providers. The method includes upon redemption of vouchers, facilitating payment amount to the healthcare service provider for the one or more claims associated with the one or more vouchers.

### TECHNICAL FIELD

Embodiments of the disclosure relate generally to health plan design and, more particularly to, computer implemented methods and systems for health plan design administration for healthcare services.

### BACKGROUND

Health plans provide insurance coverage for medical expenditures of enrolled individuals. A health plan “member” as used herein generally refers to the enrolled individual. A “plan sponsor” generally refers to an entity, such as an employer, that pays a portion of the premiums and/or medical claims. A “premium” generally refers to an amount paid in consideration for an entity providing health insurance coverage or the like.

Traditionally, health plans have created a structure for cost-sharing with the members, herein referred to as a “plan design”. A plan design typically includes one or more of the following: deductibles, copays, coinsurance, coverage limits, and provider networks. A “deductible” generally refers to an amount during a period of time, typically a calendar year, that the member must pay before the health plan pays its share. A “copay” generally refers to a fixed amount that the member must pay on a particular visit or service and the health plan pays the remaining balance. A “coinsurance” generally refers to a percentage of total costs that the member must pay on a particular visit or service and the health plan pays the remaining balance. A “coverage limit” generally refers to a maximum amount a health plan will pay for a particular service or during a period of time, typically the lifetime of member. A “provider network” generally refers to the healthcare providers that the health plan has a contractual agreement on payment rates.

Health plans typically bifurcate the choices members have for choosing healthcare service providers based upon the contractual status of the provider. “In-network providers” refers to healthcare service providers that the health plan has favorable contractual payment rates and “out-of-network providers” refers to healthcare service providers that the health plan has unfavorable or no contractual payment rates. To incent members to use in-network providers, health plans typically make the member cost-sharing lower than for out-of-network providers by setting different deductibles, copays, coinsurance, coverage limits and the like.

Over the years, many attempts have been made by health plans and other managed care organizations to control medical expenditures by making adjustments to the aforementioned plan design components. Health Management Organizations were created to control medical expenditures by forcing members to utilize a very limited network of healthcare service providers with favorable contractual payment terms. High Deductible Health Plans and Consumer Driven Health Plans were created to incent members to shop around for healthcare services by forcing them to pay a high deductible before the health plan would share in the costs. However, according to National Health Expenditures Account data, these attempts to control medical expenditures have largely been unsuccessful with medical expenditures growing from 5% of the U.S. GDP in 1960 to nearly 18% of the U.S. GDP in 2019.

Furthermore, traditional plan designs are cumbersome and difficult for members to understand. Many plan designs contain different cost-share arrangements for the different types of service (e.g., professional or facility charges) and create confusion on the amount of payment required. Often, a member will not know amount of payment required at point of service and will only find out after-the-fact via a bill from the healthcare service provider or the health plan's explanation of benefits. Additionally, a member often has difficulty knowing what healthcare service providers are considered in-network and has to contact the health plan or healthcare service provider to verify network status.

In view of the above, there is a need for a computer implemented method and system that obviates the deficiencies of existing plan designs, along with providing other benefits.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Various embodiments of the present disclosure provide methods and systems for health plan design administration for healthcare services.

An embodiment of the invention provides, among other things, a method for a member to purchase healthcare services based upon the urgency of receiving treatment. Rather than bifurcate the purchasing decision based upon in-network and out-of-network providers, a member's purchasing decision is based upon the bifurcation of “emergency” and “planned” medical expenditure. As used herein, the term “emergency medical” refers to an event that requires immediate medical attention because of extreme bodily distress or to prevent the loss of life or permanent function. Additionally, as used herein, the term “planned medical” refers to an event that does not require immediate medical attention and can be scheduled in advance. The method includes classifying the emergency medical and planned medical expenditures based upon a predefined rule set utilizing, among other things, a list valid diagnoses and procedures.

Another embodiment of the invention provides, among other things, a method for a member to purchase emergency medical. During times of medical distress, it is unreasonable to expect a member to make a purchasing decision based upon the typical bifurcation of in-network and out-of-network provider as the member may be requiring the most readily available provider. Preferably, the member would be allowed to see any qualified and credentialed healthcare service provider and would not be financially penalized for the selection of a healthcare service provider. The method includes a member cost-share arrangement specifically for emergency medical expenditures and may include deductibles, copays and coinsurance.

Another embodiment of the invention provides, among other things, a method for a member to purchase planned medical expenditures. The method includes a way for the member to make an informed purchasing decision based upon cost and quality by using a marketplace with competing healthcare service providers. The “marketplace” is any mechanism that allows for comparison of healthcare services across different healthcare service providers with transparent pricing. The method includes a member cost-share arrangement specifically for planned medical expenditures and may include deductibles, copays and coinsurance. Preferably, the member cost-share would be directly correlated to the total cost of the planned medical expenditure and as the total cost of the planned medical went up, so would the member cost-share amount.

In another embodiment, a computer implemented method is disclosed. For an emergency medical expenditure, the method includes receiving, by a processor, member information and one or more claims associated with the member from at least one healthcare service provider. Each claim is associated with one or more healthcare services availed by the member during the emergency medical event. The method includes processing, by the processor, the one or more claims for determining validity of each emergency medical claim of the one or more claims based on a predefined emergency medical rule set. The method further includes upon processing the one or more claims, facilitating, by the processor, a payment amount for the one or more claims of the at least one healthcare service provider based on the validity.

In another embodiment, a server system is disclosed. The server system comprises a memory to store instructions and a processor to execute the stored instructions in the memory and thereby cause the server system to receive member and claim information of a member. The member information comprises at least a member identifier and one or more claims associated with the member from at least one healthcare service provider. Each claim is associated with one or more healthcare services availed by the member during the emergency medical event. The server system is further caused to process the one or more claims for determining the validity of each claim of the one or more claims based on a predefined emergency medical rule set. The server system is furthermore caused to facilitate a payment for the one or more claims of the at least one healthcare service provider based on the validity upon processing of the one or more claims.

In another embodiment, a computer implemented method is disclosed. For a planned medical, the method includes utilizing a computer interface to present a marketplace of healthcare service providers to the member for the member to make an informed buying decision based upon quality and transparent pricing, among other things. The method includes the member prepaying for the planned medical event based upon the member's planned medical cost-share arrangement with the health plan. The method includes generating, by the processor, a voucher for the member to avail healthcare services from one or more healthcare service providers. The method further includes facilitating, by the processor, a payment amount to one or more healthcare service providers based on the redemption of the planned medical voucher to the healthcare service provider.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment of emergency medical according to some embodiments of the present invention;

FIG. 2 is an illustration of an environment of planned medical according to some embodiments of the present invention

FIG. 3 is a sequence flow diagram of emergency medical, in accordance with an embodiment of the present invention;

FIG. 4 is a sequence flow diagram of planned medical, in accordance with an embodiment of the present invention;

FIG. 5 is a functional block diagram of a system for health plan design administration platform, in accordance with an embodiment of the present invention;

FIG. 6A is an example representation of an interface of a marketplace of healthcare service provider vouchers for planned medical expenditures, in accordance with an embodiment of the present invention;

FIG. 6B is an example representation of an interface of purchased healthcare service provider vouchers for planned medical expenditures, in accordance with an embodiment of the present invention;

FIG. 6C is an example representation of a voucher generated by the planned medical voucher system, in accordance with an embodiment of the present invention;

FIG. 7 is a block diagram of a user device, in accordance with an embodiment of the present invention t; and

FIG. 8 is a block diagram of a server of FIGS. 1 and 2, in accordance with an embodiment of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide computer implemented methods and systems for health plan design administration related to payments for availing healthcare services.

When a member is needing healthcare services, a determination is made by the member if he/she is requiring immediate medical attention because of severe bodily distress or to prevent loss of life or permanent function—in other words, an emergency. If it is determined that the member is in an emergency situation, the member follows the process for emergency medical. The member avails healthcare services from a qualified and credentialed healthcare provider and presents an emergency medical insurance card to the provider that contains claim submission information. The “emergency medical insurance card” may be similar to standard health plan insurance cards and contain such information as health plan name, member id, group id, plan id and the like. The healthcare service provider uses the information on the insurance card to submit claims to health plan for any services rendered to the member.

The adjudication of emergency healthcare claims is managed by an emergency medical claim adjudication system. The emergency medical claim adjudication system determines a member responsibility for the emergency medical expenditures based upon the cost-share arrangement with the health plan. The member responsibility may be a contracted payment rate for example, a deductible amount, copay amount and a coinsurance amount, among other things. Additionally, the emergency medical claim adjudication system determines the validity of the emergency medical claims based upon a predefined rule set. If the claim is determined by the emergency medical claim adjudication system to be a valid emergency medical expenditure, the emergency medical claim adjudication system releases the payments to the healthcare service providers.

When a member is needing healthcare services and determines that he/she is not in an emergency situation, the member follows the process for purchasing planned medical expenditures. The member visits a marketplace of providers and services where an informed buying decision is made based upon quality and transparent pricing, among other things. The method includes the member prepaying for the planned medical expenditures based upon the member's planned medical expenditure cost-share arrangement with the health plan. The member is then given a system generated voucher that is redeemed at the healthcare service provider at the time of service. Payment to the healthcare service provider by the health plan is made at time of redemption of voucher.

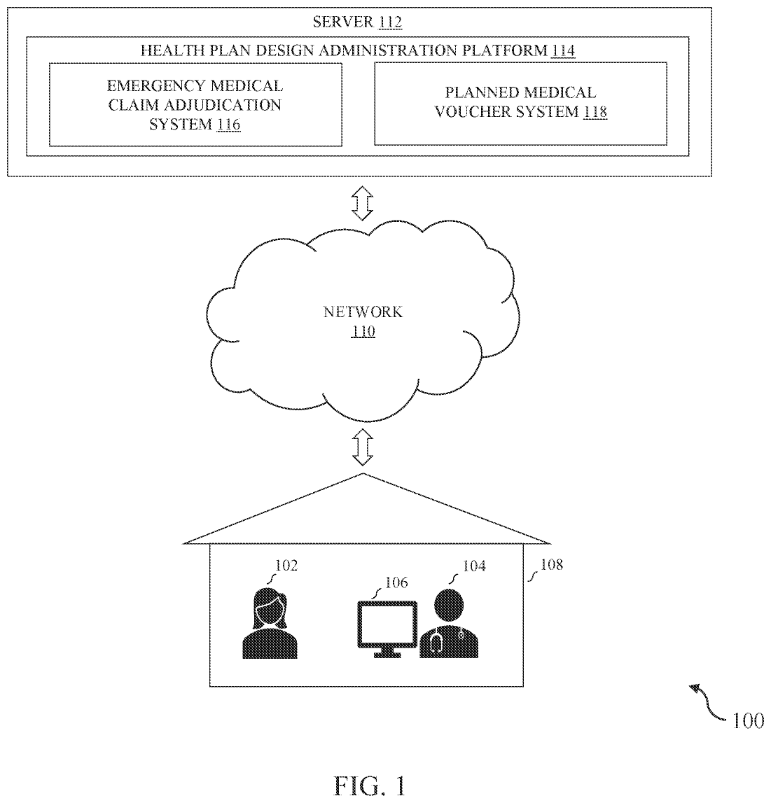

FIG. 1 shows an example representation of an environment 100 related to at least some example embodiments of the present disclosure. An example representation of the environment 100 is shown depicting a wireless communication network (e.g., a network 110) that connects entities such as, a provider 104, a healthcare facility 108 and a server 112. In some embodiments, the healthcare service providers 104 and healthcare facilities 108 may include physicians, hospitals, urgent care centers and other providers that may be used by the member 102 for an emergency medical event. It shall be noted that the healthcare service providers 104 and facilities 108 are shown for the sake of simplicity and example purposes only and the member 102 may avail healthcare services from a plurality of healthcare service providers 104 and facilities 108 during a course of the treatment of the member 102 during the emergency medical event.

In some embodiments, the server 112 comprises a health plan design administration platform 114 that is configured to manage the health plan design for members who avail healthcare services from the healthcare service providers 104 and facilities 108. It shall be noted that the healthcare facility 108 is also a healthcare provider and has been depicted as a separate entity for example purposes. The health plan design administration platform 114 includes an emergency medical claim adjudication system 116 and a planned medical voucher system 118. The emergency medical claim adjudication system 116 adjudicates and settles claims to healthcare services providers for emergency medical healthcare services availed by members and the planned medical voucher system 118 provides a marketplace where members can purchase planned medical vouchers to be redeemed with healthcare services providers.

As seen in FIG. 1, a member 102 with an emergency medical event presents to a provider 104 with a health condition that requires immediate medical attention at a healthcare facility 108. In some embodiments, the provider 104 uses the member's emergency medical insurance card to submit healthcare claims via a device 106 connected to the network 110 to the health plan design administration platform 114. In some embodiments, the device 106 may be any communication device having hardware components for enabling a UI of any commercially available healthcare claims submission software to be presented on the device 106. In some embodiments, the device 106 may be capable of being connected to a wireless communication network (such as network 110). Examples of the device 106 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

In some embodiments, the device 106 is configured to communicate with the server 112 to submit emergency medical healthcare claims through the communication network 110. In some embodiments, the communication network 110 represents any distributed communication network (wired, wireless or otherwise) for data transmission and receipt among two or more points. In some embodiments, the communication network 110 may as an example, include standard and/or cellular telephone lines, LAN or WAN links, broadband connections (ISDN, Frame Relay, ATM), wireless links, and so on. Preferably, the communication network 110 can carry TCP/IP protocol communications, and HTTP/HTTPS requests made by the user devices and the server system can be communicated over such communication networks 110. In one embodiment, the communication network 110 is the Internet, which may be a combination of various communication technologies.

In an embodiment, the healthcare service providers 104 and facilities 108 submit the claims to the emergency medical claim adjudication system 116 for the healthcare services availed by the member 102 during the emergency medical event. The emergency medical claim adjudication system 116 determines the validity of the claims submitted by the healthcare service providers 104 and facilities 108 by classifying the claims as a valid claim or an invalid claim based on the emergency medical rule set stored in the server 112. If the claims are found to be valid emergency medical claims, the server 112 may settle claims and remit payment to the healthcare service providers 104 and facilities 108. In an embodiment, the server 112 can be a cloud-based server. Alternatively, or additionally, the server 112 may be located at a centralized location. The server 112 hosts and manages the emergency medical claim adjudication system 116 and the planned medical voucher system 118 of the health plan design administration platform 114.

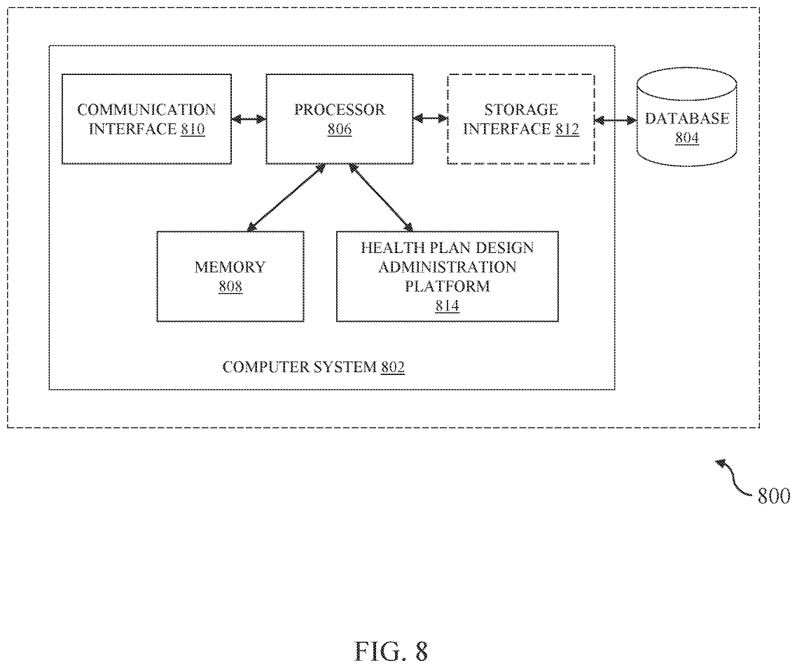

It is noted that the instructions (or the executable code) configuring the health plan administration platform 114 are stored in a memory of the server 112, and the instructions are executed by a processor (for example, a single-core or a multi-core processor) included within the server 112, as is exemplarily shown with reference to FIG. 8.

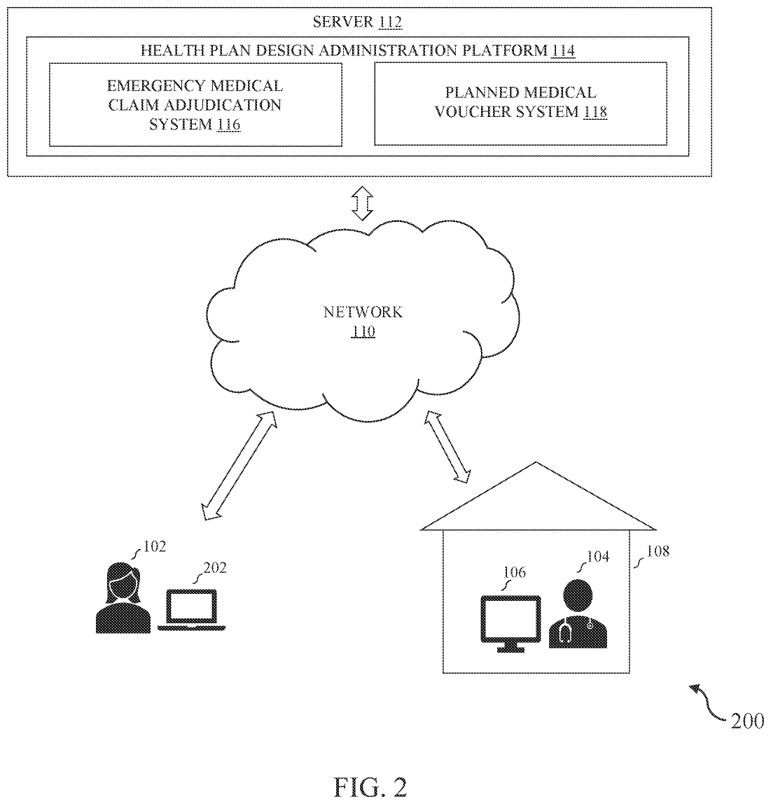

FIG. 2 shows an example representation of an environment 200 according to some embodiments of the present invention. An example representation of the environment 200 is shown depicting a wireless communication network (e.g., a network 110) that connects entities such as, the member 102, a provider 104, a healthcare facility 108 and a server 112. In some embodiments, the healthcare service providers 104 and healthcare facilities 108 may include physicians, hospitals, urgent care centers and other providers that may be used by the member 102 for a planned medical event. It shall be noted that the healthcare service providers 104 and facilities 108 are shown for the sake of simplicity and example purposes only and the member 102 may avail healthcare services from a plurality of healthcare service providers 104 and facilities 108 during a course of the treatment of the member 102 during planned medical events.

In some embodiments, the server 112 comprises a health plan design administration platform 114 that is configured to manage the health plan design for members who avail healthcare services from the healthcare service providers 104 and facilities 108. It shall be noted that the healthcare facility 108 is also a healthcare provider and has been depicted as a separate entity for example purposes. The health plan design administration platform 114 includes an emergency medical claim adjudication system 116 and a planned medical voucher system 118. The emergency medical claim adjudication system 116 adjudicates and settles claims to healthcare services providers for emergency medical healthcare services availed by members and the planned medical voucher system 118 provides a marketplace where members can purchase planned medical vouchers to be redeemed with healthcare services providers.

As seen in FIG. 2, a member 102 with a planned medical event uses a device 202 to access the planned medical voucher system 118. The planned medical voucher system 118 contains a marketplace of healthcare services providers 104 and facilities 108 from which the member 102 may purchase planned medical vouchers. The device 202 may be any communication device having hardware components for enabling a UI of the planned medical voucher system 118 to be presented on the device 202. The device 202 may be capable of being connected to a wireless communication network (such as network 110). Examples of the device 202 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

In some embodiments, the device 202 is configured to communicate with the server 112 to access the planned medical voucher system 118 through the communication network 110. The communication network 110 represents any distributed communication network (wired, wireless or otherwise) for data transmission and receipt among two or more points. The communication network 110 may as an example, include standard and/or cellular telephone lines, LAN or WAN links, broadband connections (ISDN, Frame Relay, ATM), wireless links, and so on. Preferably, the communication network 110 can carry TCP/IP protocol communications, and HTTP/HTTPS requests made by the user devices and the server system can be communicated over such communication networks 110. In one embodiment, the communication network 110 is the Internet, which may be a combination of various communication technologies.

In an embodiment, the member 102 uses the device 202 via the communication network 110 to access the UI of the planned medical voucher system 118 to make an informed purchasing decision regarding services from providers 104 and facilities 108. The member 102 purchases a voucher from the planned medical voucher system 118 and redeems the voucher when availing healthcare services from healthcare service providers 104 and facilities 108. The server 112 remits payment to the healthcare services providers 104 and facilities 108 when the voucher is redeemed by member 102.

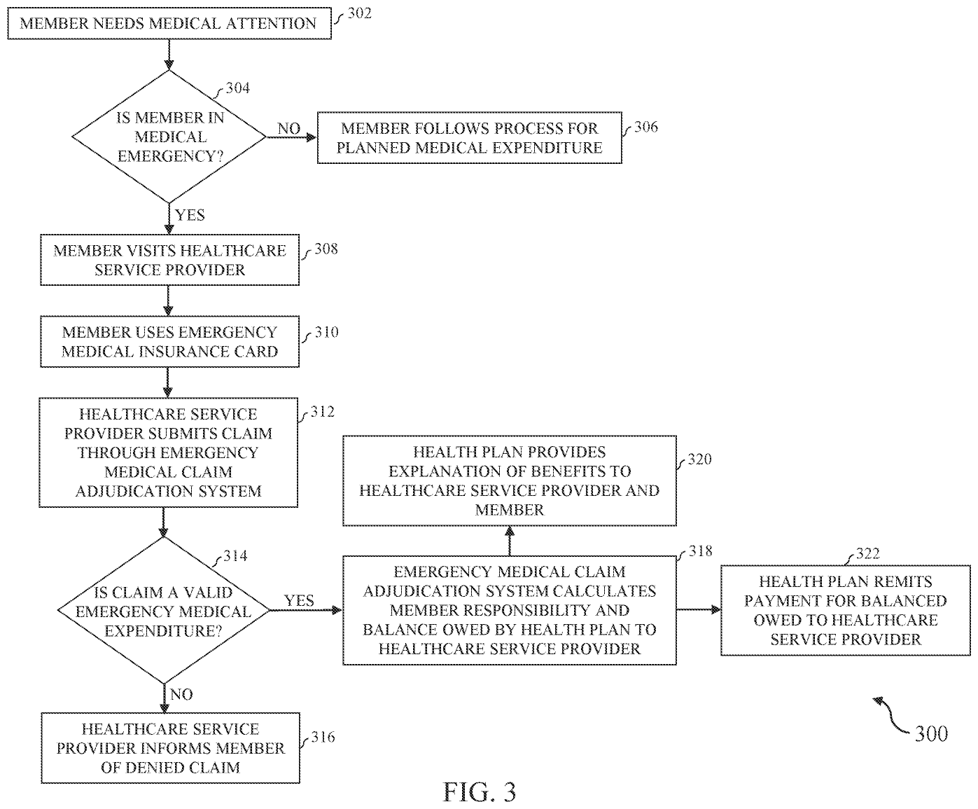

Various embodiments of FIGS. 1 and 2 are explained with reference to FIGS. 3 to 8.

FIG. 3 is an example flow diagram of a method 300 for emergency medical, in accordance with an embodiment of the present invention. The sequence of operations of the method 300 need not be necessarily executed in the same order as they are presented. Further, one or more operations may be grouped together and performed in form of a single step, or one operation may have several sub-steps that may be performed in parallel or in sequential manner.

At operation 302, a member (e.g., the member 102 (FIG. 1)) needs medical attention for a health issue he/she is facing.

At operation 304, the member (e.g., the member 102 (FIG. 1)) determines if he/she is in a medical emergency. For example, the member (e.g., the member 102 (FIG. 1)) is in extreme bodily distress or feels that without receiving immediate medical treatment, he/she would be at risk of losing life or permanent function. If the member (e.g., the member 102 (FIG. 1)) is not in a medical emergency, operation 306 is performed else operation 308 is performed.

At operation 308, the member (e.g., the member 102 (FIG. 1)) visits a healthcare service provider (e.g., the healthcare service provider 104 (FIG. 1) or the facility 108 (FIG. 1)) to receive medical treatment. In an example, the healthcare service provider may be a hospital, an urgent care center, a physician or any other qualified and credentialed medical professional equipped to handle emergency medical treatment.

At operation 310, the member (e.g., the member 102 (FIG. 1)) presents the emergency medical insurance card to the healthcare service provider (e.g., the healthcare service provider 104 (FIG. 1) or the facility 108 (FIG. 1)). In an embodiment, the emergency medical insurance card contains information such as health plan name, member id, group id, plan id and the like that is used for submitting claims to the health plan. At operation 312, the healthcare service provider (e.g., the healthcare service provider 104 (FIG. 1) or the facility 108 (FIG. 1)) uses a device (e.g., the device 106 (FIG. 1)) to submit one or more claims for the one or more healthcare services availed by the member (e.g., the member 102 (FIG. 1)) during the emergency medical event to the emergency medical claim adjudication system 116 (FIG. 1).

At operation 314, the emergency medical claim adjudication system 116 (FIG. 1) of the health plan design administration platform 114 (FIG. 1) checks whether the claims submitted by the healthcare service provider (e.g., the healthcare service provider 104 (FIG. 1) or the facility 108 (FIG. 1)) are valid claims or invalid claims based on the emergency medical rule set.

At operation 316, if the claims are found to be invalid claims, the health plan design administration platform 114 (FIG. 1) generates a notification for the member and the healthcare service provider (e.g., the healthcare service provider 104 (FIG. 1) or the facility 108 (FIG. 1)) related to the invalid claim. The notification may include reasons for classifying the claim as the invalid claim and an invalid claim payment amount to be paid by the member (e.g., the member 102 (FIG. 1)) to the healthcare service provider (e.g., the healthcare service provider 104 (FIG. 1) or the facility 108 (FIG. 1)) associated with the invalid claim. The healthcare service provider (e.g., the healthcare service provider 104 (FIG. 1) or the facility 108 (FIG. 1)) may inform the member about the denied status of the claims, at which time the healthcare service provider (e.g., the healthcare service provider 104 (FIG. 1) or the facility 108 (FIG. 1)) would need to collect payment from the member.

At operation 318, if the claims are found to be valid claims, the emergency medical claim adjudication system 114 (FIG. 1) calculates the member responsibility and balanced owed by health plan for the claim based upon the health plan's emergency medical cost-share arrangement.

In an example, if the health service providers contracted payment rate on an acute myocardial infarction with the health plan is $20,000, an emergency medical deductible for the member is $4,000 with coinsurance of 20% on amount above deductible and an out-of-pocket (OOP) max of $10,000, then the member responsibility would be:
deductible: $4,000
coinsurance: total claim $20,000 less deductible $4,000=$16,000*20% of $16,000=$3,200
total member responsibility: deductible $4,000+coinsurance $3,200=$7,200
In an example, the total member responsibility is compared to OOP max to see if OOP max applies: calculated total member responsibility on the acute myocardial infarction: $7,200 which is less than $10,000 OOP max, so member responsibility on the acute myocardial infarction is $7,200. The health plan's balance owed to the healthcare service provider of the acute myocardial infarction claim would be the total contracted payment rate of $20,000 less the member responsibility amount of $7,200=$12,800.

At operation 320, health plan provides an explanation of benefits to the healthcare service provider (e.g., the healthcare service provider 104 (FIG. 1) or the facility 108 (FIG. 1)) and the member. The explanation of benefits provides an explanation of the member responsibility of the claim.

At operation 322, the health plan remits payment for the health plan's balance owed to the healthcare service provider (e.g., the healthcare service provider 104 (FIG. 1) or the facility 108 (FIG. 1)).

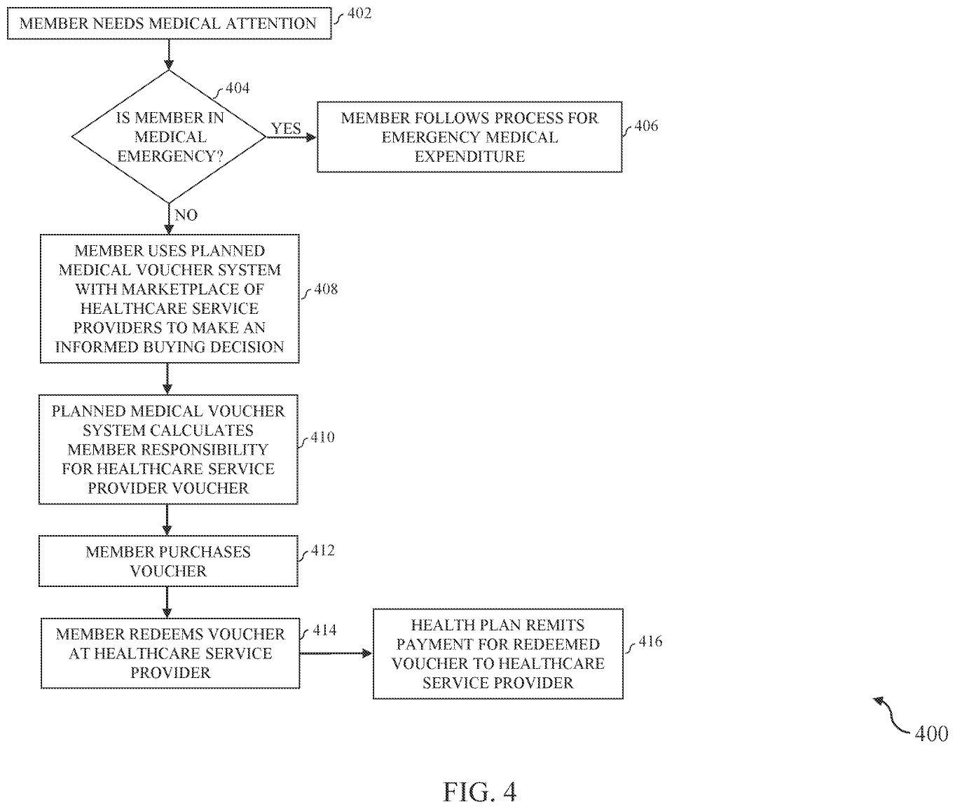

FIG. 4 is an example flow diagram of a method 400 for planned medical, in accordance with an embodiment of the present invention. The sequence of operations of the method 400 need not be necessarily executed in the same order as they are presented. Further, one or more operations may be grouped together and performed in form of a single step, or one operation may have several sub-steps that may be performed in parallel or in sequential manner.

At operation 402, a member (e.g., the member 102 (FIG. 2)) needs medical attention for a health issue he/she is facing.

At operation 404, the member (e.g., the member 102 (FIG. 2)) determines if he/she is in a medical emergency. For example, the member is in extreme bodily distress or feels that without receiving immediate medical treatment, he/she would be at risk of losing life or permanent function. If the member is in a medical emergency, operation 406 is performed else operation 408 is performed.

At operation 408, the member (e.g., the member 102 (FIG. 2)) uses a device 202 to log on to an interface (see, interface 600) provided by the planned medical voucher system 118 (FIG. 2) to compare quality and prices of competing healthcare service providers. At operation 410, the planned medical voucher system 118 (FIG. 2) calculates the member responsibility for the voucher. The member responsibility may be a contracted rate with the healthcare service provider or may be a copay amount, coinsurance amount, or some other amount as defined by the planned medical cost-share arrangement with the health plan. At operation 412, the member (e.g., the member 102 (FIG. 2)) purchases a voucher for redemption at one or more healthcare service providers (e.g., the healthcare service provider 104 (FIG. 2) or the facility 108 (FIG. 2)). At operation 414, the member (e.g., the member 102 (FIG. 2)) redeems the purchased voucher at the one or more healthcare service providers (e.g., the healthcare service provider 104 (FIG. 2) or the facility 108 (FIG. 2)). At operation 416, the health plan remits payment to the healthcare service provider (e.g., the healthcare service provider 104 (FIG. 2) or the facility 108 (FIG. 2)) for the redeemed voucher.

In an example, a member is in need of a magnetic resonance imaging (MRI) with contrast scan and logs in to the planned medical voucher system 118 (FIG. 2). Using the interface of the planned medical voucher system (see, interface 600), the member compares prices and quality ratings of the different healthcare service providers offering an MRI with contrast scan. Based upon price and quality, among other things, the member purchases a voucher that can be redeemed at one or more healthcare service providers. The member follows any instructions provided on the voucher for scheduling the healthcare service with the healthcare service provider. When the member receives the MRI with contrast scan, he/she redeems the voucher with the healthcare service provider. The health plan is notified of the redemption of the voucher by the member and/or the healthcare service provider. At that time, the health plan remits payment for the contracted rate of the MRI with contrast scan to the healthcare service provider.

In an example, if the health service providers contracted payment rate on an MRI with contrast scan with the health plan is $1,000 and the member responsibility is a copay in the amount of $100, then when the member logs in to the interface of the planned medical voucher system (see, interface 600), the member will see the copay amount of $100 as the price of the voucher. The member purchases the voucher and at that time pays $100. When the member redeems the voucher with the healthcare service provider, the health plan remits the contracted rate of $1,000 to the healthcare service provider. The health plan cost-share amount is $900 (i.e., the contracted rate of $1,000 less the prepaid member copay of $100).

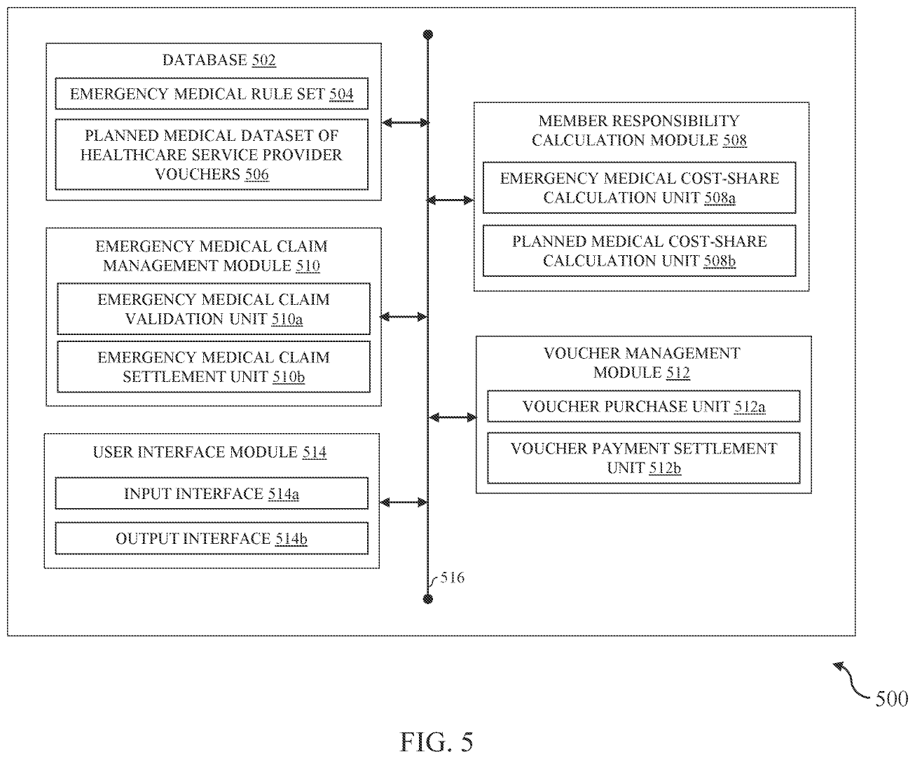

FIG. 5 is a block diagram of a system 500 for health plan design administration of healthcare services, in accordance with an embodiment of the present invention. In some embodiments, the system 500 may be embodied in a server system, for example, the server 112 (FIGS. 1-2) or an electronic device, such as, the device 106 (FIGS. 1-2) accessible by a healthcare service provider, such as the physician 104 (FIGS. 1-2) or device 202 accessible by the member 102 (FIG. 2). The system 500 comprises a database 502, a user interface module 514, a member responsibility calculation module 508, an emergency medical claim management module 510, a voucher management module 512, and a centralized circuit system 516.

In some embodiments, the database 502 is configured to store the emergency medical rule set 504 used to validate emergency medical claims. The emergency medical rule set 504 is predefined and may contain a list of valid procedure and diagnoses codes, among other things. In some embodiments, the database 502 is also configured to store the planned medical dataset of healthcare service provider vouchers 506. The planned medical dataset of healthcare service provider vouchers 506 is the plurality of healthcare service provider vouchers offered to the member.

In some embodiments, the user interface (UI) module 514 is configured to present one or more UIs for facilitating health plan design administration for healthcare services availed by the member 102. In some embodiments, the UI module 514 comprises an input interface 514a and an output interface 514b. The input interface 514a is configured to receive member information associated with the member 102 (FIG. 2). The member information may include but are not limited to member identifier and member login information associated with the member. Examples of the input interface 514a may include, but are not limited to, a keyboard, a mouse, a joystick, a keypad, a touch screen, soft keys, and the like. The output interface 514b is configured to display vouchers available for purchase by the member from the planned medical voucher system 118 (FIG. 2), among other things. In some embodiments, the output interface 514b is also configured to display a voucher that may be downloaded and printed by the member. Examples of the output interface 514b may include, but are not limited to, a display such as a light emitting diode display, a thin-film transistor (TFT) display, a liquid crystal display, an active-matrix organic light-emitting diode (AMOLED) display, and the like.

In some embodiments, the member responsibility calculation module 508 is in communication with the member the database 502, the emergency medical claim management module 510, the voucher management module 512 and the UI module 514. In some embodiments, the member responsibility calculation module 508 is configured to calculate a member responsibility for an emergency medical claim 508a or to calculate a member responsibility for presenting the price of a voucher for a planned medical expenditure 508b. In an embodiment, the member responsibility of an emergency medical event may include a contracted rate, a deductible amount, a copay amount, a coinsurance amount and an out of pocket (OOP) max amount, among other things. In another embodiment, the member responsibility of a planned medical voucher may include a contracted rate, a deductible amount, a copay amount and a coinsurance amount, among other things.

In some embodiments, the emergency claim management module 510 is in communication with the database 502, the member responsibility calculation module 508 and the UI module 514. The emergency claim management module 510 is configured to receive, manage and settle claims submitted by the healthcare service providers 104 (FIG. 1) and facilities 108 (FIG. 1) for the healthcare services availed by the member 102 (FIG. 1) during an emergency medical event. In some embodiments, the emergency claim management module 510 includes an emergency medical claim validation unit 510a and an emergency medical claim settlement unit 510b. In some embodiments, the emergency medical claim validation unit 510a is configured to determine the validity of the emergency medical claims by classifying each claim as a valid emergency medical claim or an invalid emergency medical claim based on the emergency medical rule set stored in the database 502. In case of an invalid claim, the claim validation unit 510a is further configured to generate a notification for the member 102 (FIG. 1) and the healthcare service provider 104 (FIG. 1) or facilities 108 (FIG. 1) related to the invalid claim. The notification may include reasons for determining the invalid claim and an invalid claim payment amount to be paid by the member 102 (FIG. 1) to the healthcare service provider 104 (FIG. 1) or facilities 108 (FIG. 1) associated with the invalid claim. In some embodiments, the emergency medical claim settlement unit 510b is in communication with the emergency medical claim validation unit 510a. In some embodiments, the emergency medical claim settlement unit 510b is configured to settle claims that are found valid by the emergency medical claim validation unit 510a to respective healthcare service providers 104 (FIG. 1) and facilities 108 (FIG. 1) from whom the member had availed healthcare services for the emergency medical event.

In an embodiment, upon determining at least one valid claim, the emergency medical claim settlement unit 510b is configured to facilitate payment of a payment amount (based on a contracted payment rate) for the healthcare service associated with the at least one valid claim to the healthcare service provider 104 (FIG. 1) or facility 108 (FIG. 1).

In some embodiments, the voucher management module 512 is in communication with the database 502, the member responsibility calculation module 508 and the UI module 514. The voucher management module 512 is configured to present to the member a plurality of healthcare service provider vouchers available for purchase and to settle payment to healthcare service providers 104 (FIG. 2) and facilities 108 (FIG. 2) for redeemed vouchers. The voucher management module 512 includes a voucher purchase unit 512a and a voucher settlement unit 512b. The voucher purchase unit 512a is configured to present to the member a plurality of healthcare service provider vouchers available for purchase and to accept member payment for the member responsibility amount of the voucher. The accepted form of member payment for the voucher may include a credit card, a debit card, a health savings account (HSA) card, a health reimbursement arrangement (HRA) card, and the like. In some embodiments, the voucher payment settlement unit 512b is in communication with the voucher purchase unit 512a. In some embodiments, the voucher payment settlement unit 512b is configured to settle payment to healthcare service providers 104 (FIG. 2) and facilities 108 (FIG. 2) for any vouchers redeemed by the member 102 (FIG. 2).

In some embodiments, the database 502, the user interface module 514, the member responsibility calculation module 508, the emergency medical claim management module 510, and the voucher management module 512 are configured to communicate with each other via or through the centralized circuit system 516. In some embodiments, the centralized circuit system 516 may be various devices configured to, among other things, provide or enable communication between the modules (502-514) of the system 500. In certain embodiments, the centralized circuit system 516 may be a central printed circuit board (PCB) such as a motherboard, a main board, a system board, or a logic board. The centralized circuit system 516 may also, or alternatively, include other printed circuit assemblies (PCAs) or communication channel media. In some embodiments, the centralized circuit system 516 may include appropriate storage interfaces to facilitate communication among the modules (502-514). Some examples of the storage interface may include, for example, an Advanced Technology Attachment (ATA) adapter, a Serial ATA (SATA) adapter, a Small Computer System Interface (SCSI) adapter, a RAID controller, a SAN adapter or a network adapter.

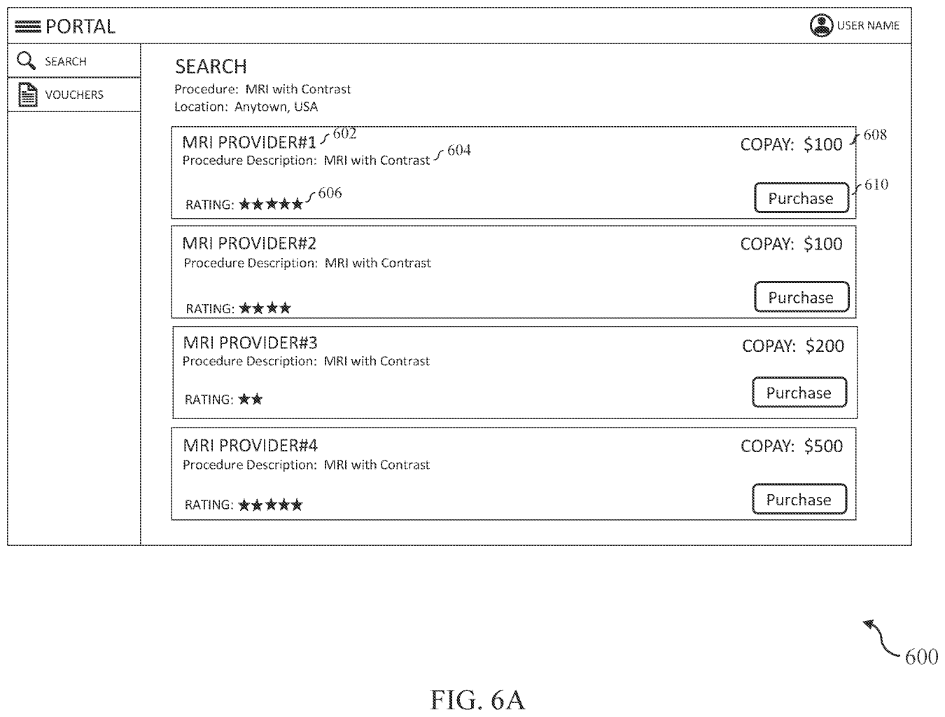

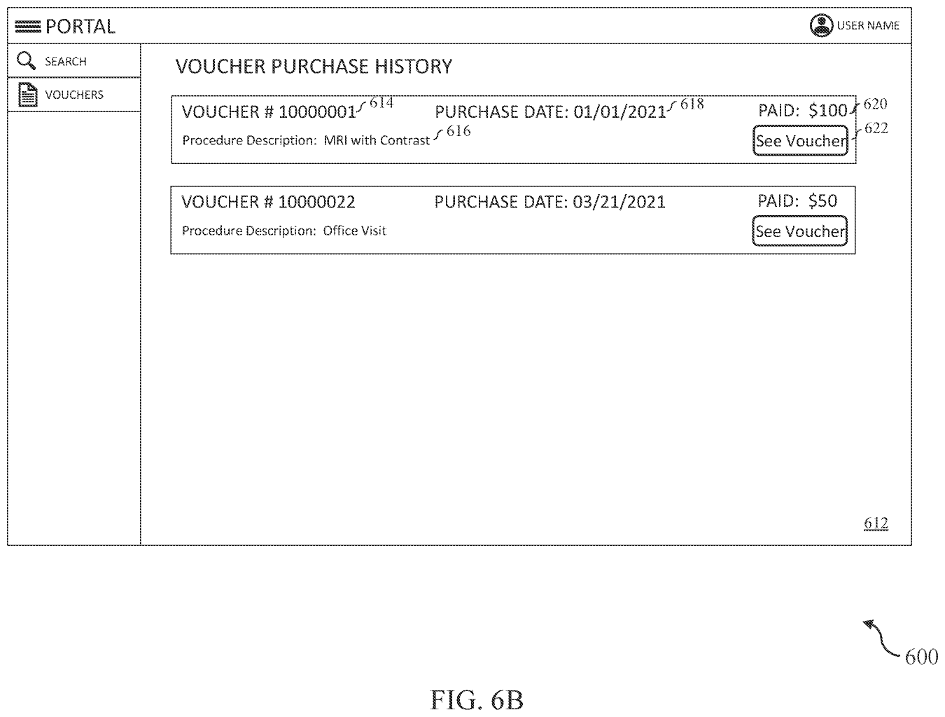

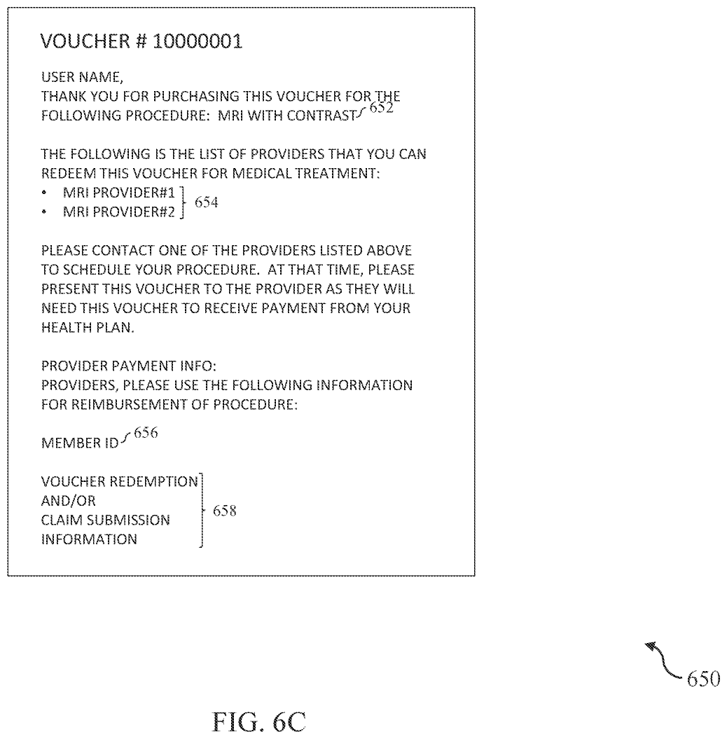

FIG. 6A is an example representation of an interface 600 of the planned medical voucher system 118, in accordance with an embodiment of the present invention. It shall be noted that the interface 600 as described in FIG. 6A is accessible to a member (such as the member 102 (FIG. 2)).

In some embodiments, the interface 600 includes the ability for a member (e.g., the member 102 (FIG. 2)) to search for specific planned medical healthcare service and see the list of healthcare service provider vouchers available for purchase of the specific planned medical healthcare service. The search details of each voucher may include, among other things, the name of the provider 602, the medical healthcare service description 604, a quality rating 606, member responsibility payment amount 608 and the ability to purchase the voucher 610. Upon clicking on the “Purchase” button 610, the member (e.g., the member 102 (FIG. 2)) remits payment for the member responsibility amount by using a credit card, a debit card, a health savings account (HSA) card, a health reimbursement arrangement (HRA) card, and the like.

FIG. 6B is an example representation of the voucher purchase history page 612 of the interface 600 for member purchases of vouchers, in accordance with an embodiment of the present invention. The page 612 includes the list of the member's (e.g., the member 102 (FIG. 2)) purchased vouchers. The voucher purchase history details of each voucher may include, among other things, the voucher number 614, the medical healthcare service description 616, the purchase date of voucher 618, the member paid amount 620 and functionality to view the voucher 622. Upon clicking on the “See Voucher” button 622, the member is shown voucher 650 (see, FIG. 6C).

FIG. 6C is a schematic representation of voucher 650 generated by the interface 600 is illustrated, in accordance with an embodiment of the present invention. In some embodiments, the voucher 650 comprises the medical healthcare service covered by the voucher 652, information about the healthcare service providers 654, the member identification 656 and the healthcare service provider reimbursement information 658.

As seen in FIG. 6C, the voucher 650 displays text 652 indicating the medical healthcare service that is covered by the voucher. In some embodiments, the voucher also contains a list of the healthcare service providers 654 available for the member in possession of the voucher 650. It shall be noted that the healthcare service providers can be a healthcare service provider (e.g., healthcare service providers 104 (FIG. 2)) or facility (e.g., the facility 108 (FIG. 2)). In some embodiments, the voucher 650 also includes member identification details 656 and information on the reimbursement process for the healthcare service provider 658. It should be noted that in some embodiments, the reimbursement process 658 may be a voucher redemption process as defined by the health plan. Alternatively, in some embodiments, the reimbursement process may be similar to a standard healthcare claim adjudication process.

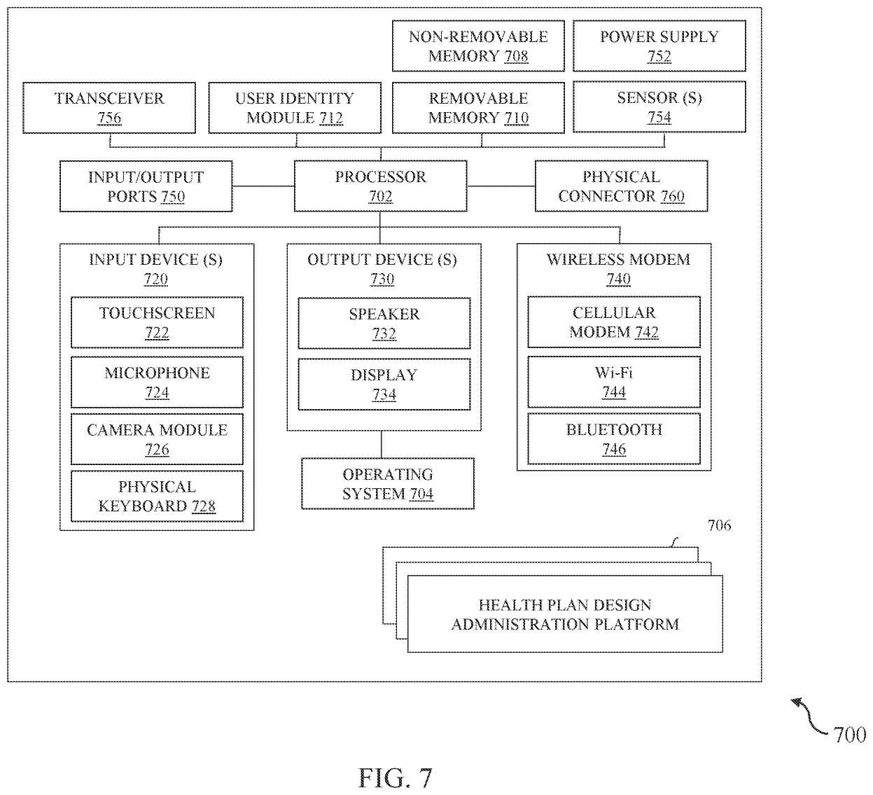

FIG. 7 shows a simplified block diagram of an electronic device 700 capable of implementing the various embodiments of the present disclosure. In some embodiments, the electronic device 700 may be an example of the device 106 (FIGS. 1-2) or device 202. In an embodiment, the various operations related to emergency medical claim adjudication system 116 (FIGS. 1-2) or planned medical voucher system 118 (FIGS. 1-2) can be facilitated using a health plan design administration platform 114 (FIGS. 1-2) installed in the electronic device 700. It should be understood that the electronic device 700 as illustrated and hereinafter described is merely illustrative of one type of device and should not be taken to limit the scope of the embodiments. As such, it should be appreciated that at least some of the components described below in connection with that the electronic device 700 may be optional and thus in an embodiment may include more, less or different components than those described in connection with the embodiment of the FIG. 7. As such, among other examples, the electronic device 700 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

In some embodiments, the illustrated electronic device 700 includes a controller or a processor 702 (e.g., a signal processor, microprocessor, ASIC, or other control and processing logic circuitry) for performing such tasks as signal coding, data processing, image processing, input/output processing, power control, and/or other functions. In some embodiments, an operating system 704 is configured to control the allocation and usage of the components of the electronic device 700 and support for one or more applications programs (see, the health plan design administration platform 114 (FIGS. 1-2)) that implements one or more of the innovative features described herein. In some embodiments, the applications 706 may include the health plan design administration platform and common mobile computing applications (e.g., telephony applications, email applications, calendars, contact managers, web browsers, messaging applications such as USSD messaging or SMS messaging or SIM Tool Kit (STK) application) or any other computing application. In some embodiments, the health plan design administration platform 706 is configured to be in operative communication with other applications for example, through the OS or using API Calls, for facilitating emergency medical claim adjudication 116 (FIGS. 1-2) or planned medical voucher system 118 (FIGS. 1-2).

In some embodiments, the illustrated electronic device 700 includes one or more memory components, for example, a non-removable memory 708 and/or a removable memory 710. In some embodiments, the non-removable memory 708 and/or the removable memory 710 may be collectively known as a database. In some embodiments, the non-removable memory 708 can include RAM, ROM, flash memory, a hard disk, or other well-known memory storage technologies. In some embodiments, the removable memory 710 can include flash memory, smart cards, or a Subscriber Identity Module (SIM). In some embodiments, the one or more memory components can be used for storing data such as, emergency medical rule set, claim requests and/or code for running the operating system 704 and the health plan design administration platform. In some embodiments, the electronic device 700 may further include a user identity module (UIM) 712. In some embodiments, the UIM 712 may be a memory device having a processor built in. In some embodiments, the UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

In some embodiments, the electronic device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include but are not limited to a speaker 732 and a display 734. Other possible output devices can include piezoelectric or other haptic output devices. Some devices can serve more than one input/output function. For example, the touch screen 722 and the display 734 can be combined into a single input/output device.

In some embodiments, a wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

In some embodiments, the electronic device 700 can further include one or more input/output ports 750, a power supply 752, one or more sensors 754 for example, an accelerometer, a gyroscope, a compass, or an infrared proximity sensor for detecting the orientation or motion of the electronic device 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

FIG. 8 illustrates a block diagram of a server 800, which may be an example of the server 112 (FIGS. 1-2), in accordance with an embodiment of the present disclosure. In some embodiments, the server 800 includes a computer system 802 and one or more databases.

In some embodiments, the computer system 802 includes a processor 806 for executing instructions. In some embodiments, instructions may be stored in, for example, but not limited to, a memory 808. The processor 806 may include one or more processing units (e.g., in a multi-core configuration). The processor 806 is operatively coupled to a communication interface 810 and a health plan design administration platform 814. In some embodiments, the processor 806 may also be operatively coupled to a database 804. The database 804 is any computer-operated hardware suitable for storing and/or retrieving data such as, the emergency medical rule set. In some embodiments, the database 804 is also configured to store the planned medical dataset of healthcare service provider vouchers. In some embodiments, the database 804 may include multiple storage units such as hard disks and/or solid-state disks in a redundant array of inexpensive disks (RAID) configuration. In some embodiments, the database 804 may include, but not limited to, a storage area network (SAN) and/or a network attached storage (NAS) system or cloud storage. In some alternate embodiments, the database 804 may also include magnetic storage devices (such as hard disk drives, floppy disks, magnetic tapes, etc.), optical magnetic storage devices (e.g., magneto-optical disks), semiconductor memories (such as mask ROM, PROM (programmable ROM), EPROM (erasable PROM), Phase-change memory, flash ROM, RAM (random access memory)), etc.

In some embodiments, the database 804 is integrated within computer system 802. For example, computer system 802 may include one or more hard disk drives as database 804. In other embodiments, database 804 is external to computer system 802 and may be accessed by the computer system 802 using a storage interface 812. The storage interface 812 is any component capable of providing the processor 806 with access to the database 804. The storage interface 812 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 806 with access to the database 804.

In some embodiments, the memory 808 is a storage device embodied as one or more volatile memory devices, one or more non-volatile memory devices, and/or a combination of one or more volatile memory devices and non-volatile memory devices, for storing micro-contents information and instructions. The memory 808 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The health plan design administration platform 814 is an example of the health plan design administration platform 114 explained with reference to FIGS. 1 and 2. The health plan design administration platform 814 may be embodied within the computer system 802 and includes an emergency medical claim adjudication system and a planned medical voucher system (not shown in FIG. 8) for health plan design administration. The processor 806 interacts with the health plan design administration platform 114 (FIGS. 1-2) to operate the emergency medical claim adjudication system 116 (FIGS. 1-2) and the planned medical voucher system 118 (FIGS. 1-2).

The server 800 as illustrated and hereinafter described is merely illustrative of a system that could benefit from embodiments of the invention and, therefore, should not be taken to limit the scope of the invention. It may be noted that the server 800 may include fewer or more components than those depicted in FIG. 8. As explained above, the server 800 may be included within or embody an electronic device. Moreover, the server 800 may be implemented as a centralized system, or, alternatively, the various components of server 800 may be deployed in a distributed manner while being operatively coupled to each other.

The disclosed systems and methods with reference to FIGS. 1 to 8, or one or more operations of the flow diagrams 300 and 400 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application and\or implementation without departing from the spirit or scope of the claims.

What is claimed is:

1. A method for health plan design administration that bifurcates a member's healthcare services purchase decision between emergency medical and planned medical events, the method comprising:
if for an emergency medical event,
receiving, by a processor, member information of a member, the member information comprising at least a member identifier associated with the member;
receiving, by the processor, one or more claims associated with the member from at least one healthcare service provider of the one or more healthcare service providers, each claim being associated with one or more healthcare services availed by the member during the emergency medical event;
processing, by the processor, the one or more claims for determining validity of each claim of the one or more claims based on a predefined emergency medical rule set;
calculating, by the processor, the member responsibility of the one or more claims of the emergency medical event; and
upon processing the one or more claims, facilitating, by the processor, a payment amount for the one or more claims of the at least one healthcare service provider based on the validity;
if for a planned medical event,
receiving, by the processor, member login information of the member to the member portal;
presenting, by the processor, one or more healthcare service vouchers available for purchase by the member, each voucher representing one or more healthcare services from the one or more healthcare service providers available to the member during the planned medical event;
calculating, by the processor, the member responsibility of the healthcare service voucher;
processing, by the processor, member payment for the member responsibility of the one or more healthcare service vouchers;
generating, by the processor, a voucher for the member to avail healthcare services from the one or more healthcare service providers for the planned medical event, the voucher comprising reimbursement information for the healthcare services availed by the member from the one or more healthcare service providers;
upon redemption of voucher, facilitating, by the processor, a reimbursement payment amount for the one or more claims associated with the voucher of the one or more healthcare service providers.

2. The method as claimed in claim 1, wherein calculating the member responsibility comprises:
if for an emergency medical event,
accessing, by the processor, the emergency medical cost-share information of the member; and
calculating, by the processor, the member responsibility based on the emergency medical cost-share information;
if for a planned medical event,
accessing, by the processor, the planned medical cost-share information of the member for each voucher; and
calculating, by the processor, the member responsibility voucher price based on the planned medical cost-share information.

3. The method as claimed in claim 1, wherein processing the one or more emergency medical claims comprises:
classifying, by the processor, the one or more claims as a valid claim or an invalid claim; and
facilitating, by the processor, a notification for the member and the at least one healthcare service provider related to the valid or the invalid claim, the notification comprising reasons for determining the valid or the invalid claim.

4. The method as claimed in claim 3, further comprising:
upon determining the valid claim, accessing, by the processor, a contracted payment rate for payment of at least a part of the payment amount for the one or more healthcare services associated with the valid claim; and
facilitating, by the processor, payment of the payment amount for the valid claim associated with the one or more healthcare service providers.

5. The method as claimed in claim 1, wherein processing the redemption of one or more planned medical vouchers comprises:
upon redemption of voucher, accessing, by the processor, a contracted payment rate for payment of at least a part of the payment amount for the one or more healthcare services associated with the voucher; and
facilitating, by the processor, payment of the payment amount for the one or more claims of the one or more vouchers associated with the one or more healthcare service providers.

6. The method as claimed in claim 1, wherein the voucher comprises one or more of:
the member information;
the reimbursement information; and
one or more healthcare services covered by the voucher.

7. A server system, comprising:
a memory configured to store instructions; and
a processor configured to execute the instructions stored in the memory and thereby cause the server system to perform:
if for an emergency medical event,
receiving member information of a member, the member information comprising at least a member identifier associated with the member;
receiving one or more claims associated with the member from at least one healthcare service provider of one or more healthcare service providers, each claim being associated with one or more healthcare services availed by the member during the emergency medical event;
processing the one or more claims for determining validity of each claim of the one or more claims based on a predefined emergency medical rule set;
calculating the member responsibility of the claims of the emergency medical event; and
upon processing the one or more claims, facilitating a payment amount for the one or more claims of the at least one healthcare service provider based on the validity;
if for a planned medical event,
receiving member login information of the member to the member portal;
presenting one or more healthcare service vouchers available for purchase by the member, each voucher representing one or more healthcare services from the one or more healthcare service providers available to the member during the planned medical event;
calculating the member responsibility of the healthcare service voucher;
processing member payment for the member responsibility of the one or more healthcare service vouchers;
generating a voucher for the member to avail healthcare services from one or more healthcare service providers for the planned medical event, the voucher comprising reimbursement information for the healthcare services availed by the member from the one or more healthcare service providers;
upon redemption of voucher, facilitating a reimbursement payment amount for the one or more claims associated with the voucher of the one or more healthcare service providers.

8. The server system as claimed in claim 7, wherein for calculating the member responsibility, the server system is further configured to perform at least:
if for an emergency medical event,
accessing the emergency medical cost-share information of the member; and
calculating the member responsibility based on the emergency medical cost-share information;
if for a planned medical event,
accessing the planned medical cost-share information of the member for each voucher; and
calculating the member responsibility voucher price based on the planned medical cost-share information.

9. The server system as claimed in claim 7, wherein for processing the one or more emergency medical claims, the server system is further configured to perform at least:
classifying the one or more claims as a valid claim or an invalid claim; and
facilitating a notification for the member and the at least one healthcare service provider related to the valid or the invalid claim, the notification comprising reasons for determining the valid or the invalid claim.

10. The server system as claimed in claim 9, wherein the server system is further configured to perform at least:
upon determining the valid claim, accessing a contracted payment rate for payment of at least a part of the payment amount for the one or more healthcare services associated with the valid claim; and
facilitating payment of the payment amount for the valid claim associated with the one or more healthcare service providers.

11. The method as claimed in claim 7, wherein processing the redemption of one or more planned medical vouchers, the server system is further configured to perform at least:
upon redemption of voucher, accessing a contracted payment rate for payment of at least a part of the payment amount for the one or more healthcare services associated with the voucher; and
facilitating payment of the payment amount for the one or more claims of the one or more vouchers associated with the one or more healthcare service providers.

12. The server system as claimed in claim 7, wherein the voucher comprises one or more of:
the member information;
the reimbursement information; and
one or more healthcare services covered by the voucher.
